(19) United States
(12) Patent Application Publication
(10) Pub. No.: US 2004/0263935 A1
(43) Pub. Date: Dec. 30, 2004

(54) Scanner

(76) Inventors: Heinz Keiser, Stallikon (CH); Claudia Keiser, Stallikon (CH)

Correspondence Address: BROWDY AND NEIMARK, P.L.L.C., 624 NINTH STREET, NW, SUITE 300, WASHINGTON, DC, 20001-5303, US

(21) Appl. No.: 10/836,247

(22) Filed: May 3, 2004

(30) Foreign Application Priority Data
May 22, 2003 (CH) 2003 0915/03

(51) Int. Cl. H02K 21/12

(52) U.S. Cl. 359/199

(57) ABSTRACT

The scanner has a scanner motor, with a stator (5) and rotor (2), and a mirror (3) connected to the rotor (2). The rotor (2) is positionally controlled by means of magnetic field strength measurement. For this purpose, the rotor (2) is connected to a permanent magnet (7) whose magnetic field is measured with the aid of at least one magnetic field strength sensor (8). The output voltage of the magnetic field strength sensor (8) is compared with a desired value, and the power supply of the rotor (2) is adjusted on the basis of the difference determined. The scanner according to the invention can be produced more cost effectively and with a smaller overall volume than previously.

The invention relates to a scanner with a scanner motor that has a stator and a rotor mounted in the latter, and with a mirror connected to the rotor for deflecting a beam, in particular a laser beam.

Galvanometer scanners that operate with a position sensor (closed-loop operation) and without a position sensor (open-loop operation) are known in the prior art. Preferred and actual values are processed in a control circuit (PD/PID controller) in the case of a scanner with a position sensor. This permits exact positioning of the driven mirror over the scanning region mentioned. Overshooting and undershooting of the mirror can be largely eliminated given optimum adjustment of the drivers to the mirror mass used. Typical applications of these galvanometer scanners are: laser marking, laser resistance trimmers, laser measurement technology, laser printing industry, laser microscopy, laser light shows.

These galvanometer scanners have proved themselves in practice.

A scanner with oscillating movement of the mirror has been disclosed in the prior art in EP-A-0 241 430. This mirror serves for the purpose of deflecting a laser beam in an oscillating fashion for the purpose of linewise scanning of images. The scanner motor is a DC motor fed with alternating current such that the rotor executes a harmonic oscillation. A magnet with a magnetic pole directed radially outward is fastened on a mirror carrier in order to fix a central oscillation position. A further magnet is attached at a fixed location on a housing, and so there is a counterpole opposite the pole of the other magnet. Deflecting the mirror requires the application of a force that diminishes with an increase in the mutual spacing of the two magnets.

It is the object of the invention to create a scanner of the type mentioned that can be produced more cost effectively and in a more compact design.

The object is achieved in the case of a scanner motor of the generic type by virtue of the fact that the rotor is positionally controlled by means of magnetic field strength measurement. It has emerged that such positional control of the rotor enables very short reaction times and, in addition, a very compact and light design. In addition, it is scarcely affected by external influences such as, for example, foreign bodies, vibrations and light. The substantially simpler construction permits a substantially more cost effective production. Advantageous, in addition, are the higher electrical stability, a lesser drift, less development of heat and a lower mass, and thus a more energy-friendly operation.

A particularly cost effective and compact design results when, in accordance with a development of the invention, the rotor has a permanent magnet that acts on a magnetic field strength sensor mounted at a fixed location on the stator. A constant input voltage (sensor driver voltage) supplied to the magnetic field strength sensor feeds a bridge circuit (magnetic field strength measuring bridge). This results in a variable output voltage (electric signal) that is proportional to the change in the magnetic field strength as a function of the deflection of the permanent magnet fastened on the rotor. Magnetic field strength sensors are known per se and available cost effectively. In addition, they are available with high sensitivity. Such magnetic field strength sensors are on offer, for example, from Philips under the type designations of KMZ-10 and KMZ-51/52.

Particularly short reaction times and a high degree of functional reliability are achieved when, in accordance with a development of the invention, a variable output voltage of the magnetic field sensor is compared with a desired value, and the power supply of the rotor is adjusted on the base of the difference between these two values.

A particularly suitable positional control results when, in accordance with a development of the invention, the difference between the signal of the magnetic field sensor and the desired voltage is calculated with the aid of an analog computer.

The permanent magnet is arranged in a rotationally fixed fashion on the rotor and has a south pole and north pole situated diametrically opposite one another.

In order to prevent external magnetic influences, it is provided in accordance with a development of the invention that the scanner motor has means for magnetic shielding. These means have a sleeve, in particular.

Further advantageous features emerge from the dependent patent claims, the following description and the drawing.

Exemplary embodiments of the invention are explained in more detail below with the aid of the drawing, in which:

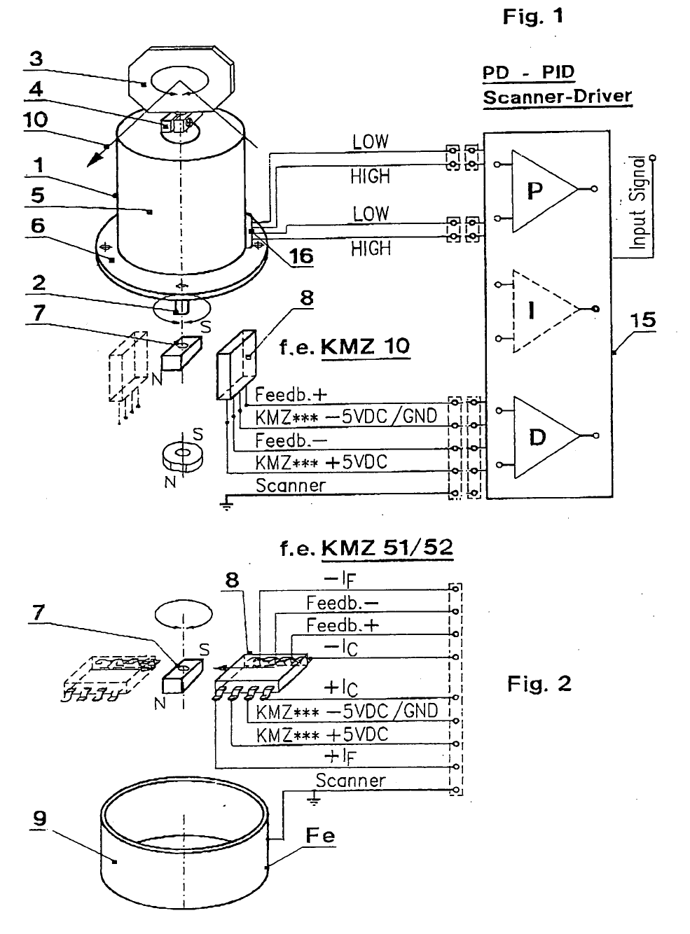

FIG. 1 shows a schematic view of a scanner according to the invention, parts being pulled apart from one another for graphical reasons;

FIG. 2 shows a schematic of a permanent magnet to be connected to the rotor, and of one or two magnetic field strength sensors;

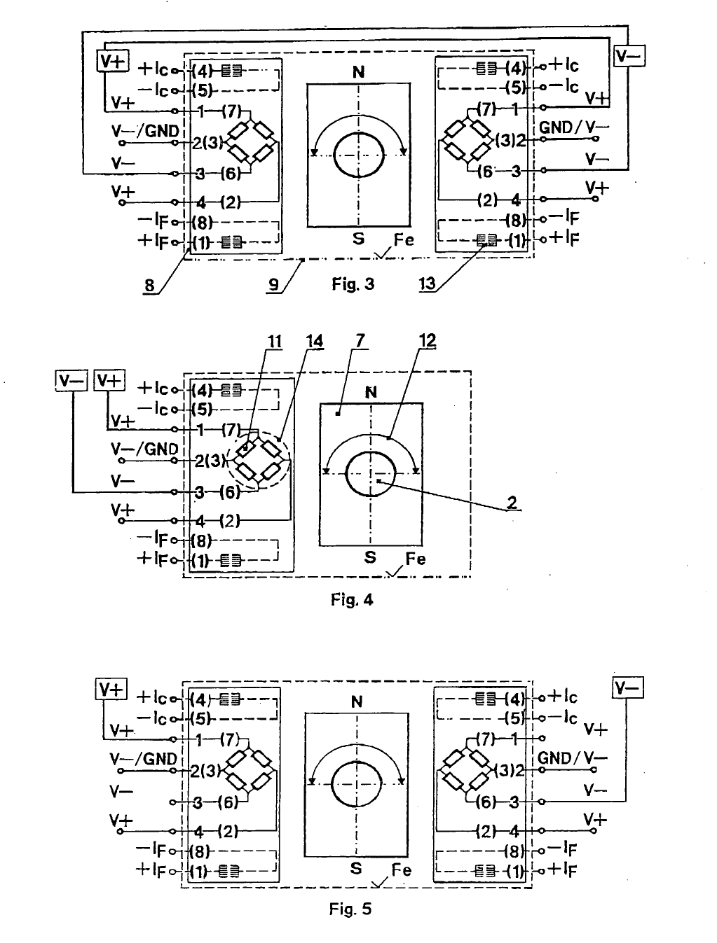

FIG. 3 shows a schematic of a design with two magnetic field strength sensors and a permanent magnet,

FIG. 4 shows a schematic of a design with one magnetic field strength sensor and a permanent magnet, and

FIG. 5 shows a further design with two magnetic field strength sensors and a permanent magnet.

The scanner 1 shown in FIG. 1 has a rotor (not shown here) with a shaft 2 that is mounted in a stator 5. Fastened on one end of the shaft 2 with the aid of a mirror holder 4 is a mirror 3 that experiences a deflection corresponding to the movement of the shaft 2. The mirror 3 connected to the shaft 2 is correspondingly moved, and a beam 10, in particular a laser beam, reflected at the mirror 3 is correspondingly deflected. The deflected beam 10 can be used, for example, to mark points or draw a line on a wall. For two-dimensional applications, the beam 10 will run in a known way at two scanners 1 at right angles to one another. Inscriptions, for example, are possible thereby. The scanner 1 is therefore known per se.

The shaft 2 is mounted like the stator 5 mentioned, which has a radially outwardly extending flange 6 in order to be fastened. Connected to the shaft 2 in a rotationally fixed fashion is a permanent magnet 7 that, in accordance with FIGS. 3, 4 and 5 has a south pole S and a north pole N. The permanent magnet 7 can be a separately produced permanent magnet, or else the permanent magnet on the rotor. In the design shown, the permanent magnet 7 is a separately produced part connected to the shaft 2 in a rotationally fixed fashion. If the shaft 2 is rotated about its longitudinal axis, the permanent magnet 7 executes the same movement, which is performed in FIGS. 3, 4 and 5 in a direction of the double arrow 12. A bridge circuit 14 is fed from a constant input voltage V+ (sensor driver voltage). The said movement is, of course, also executed by the two poles S and N.

Fastened on the stator 5 of the scanner 1 is a magnetic field strength sensor 8 that is exposed to the magnetic field of the permanent magnet 7. The magnetic field strength sensor 8 is arranged in a stationary fashion, while, as mentioned above, the permanent magnet 7 is moved in operation. Alternatively, it is also possible to arrange two magnetic field strength sensors 8 situated opposite one another. A second magnetic field sensor 8 is indicated in FIGS. 1 and 2 by dashed lines. The design with two magnetic field strength sensors 8 is shown in FIG. 3. Also conceivable in principle are designs with three or even more magnetic field strength sensors 8. These magnetic field strength sensors 8 are arranged in each case such that they are exposed to the magnetic field of the permanent magnet 7. The design with two magnetic field strength sensors 8 is particularly precise.

The magnetic field strength sensor 8 has a magnetic field strength measuring bridge 11 and two so-called flip coils 13. A bridge circuit 14 is fed from a constant input voltage V+ (sensor driver voltage). In the case of a rotating shaft 2, the magnetic field strength in the region of the magnetic field strength sensor 8 changes as a function of the deflection of the permanent magnet 7 fastened on the rotor 2. These magnetic field strength changes effect a variable output voltage V+/V− or an electric signal of the magnetic field strength sensor 8, which is proportional to the variation in the magnetic field strength in the region of the magnetic field strength sensor 8.

The difference between the variable output voltage of the magnetic field strength sensor 8 and a prescribed desired value is calculated with the aid of an electric computer 15, in particular an analog computer. The desired values are generated and input in any desired way. The power supply of the rotor is adjusted and the mirror 3 is positioned as a function of this difference. Another suitable computer can be used instead of an analog computer 15. In FIG. 1, the power supply is placed at the terminal 16 of the stator 5. On the base of the above mentioned positional control of the rotor. The zero position can be detected electrically or with a torsion spring. External influences such as, for example, foreign bodies, vibrations and the like essentially have no influence on the above-named positional control. In addition, in order to prevent external magnetic influences, the scanner motor can be shielded with a shield in the form of a sleeve 9 made from iron. Essentially any curve can be followed with the aid of the beam 10 when using two scanners. In addition, points can be exactly positioned in space. The scanner 1 is suitable, for example, for inscription, for advertising purposes, for drawing and marking.

1. A scanner with a scanner motor that has a stator (5) and a rotor (2) mounted in the latter, and with a mirror (3) connected to the rotor (2) for deflecting a beam (10), in particular a laser beam, wherein the rotor (2) is positionally controlled by means of magnetic field strength measurement.

2. The scanner as claimed in claim 1, wherein for the purpose of magnetic field strength measurement at least one magnetic field strength sensor (8) is provided on the stator (5), and a permanent magnet (7) is provided on the rotor (2).

3. The scanner as claimed in claim 2, wherein a variable output voltage of the magnetic field strength sensor (8) is compared with a desired value, and wherein the power supply of the rotor (2) is adjusted on the basis of the difference determined between these two values.

4. The scanner as claimed in claim 3, wherein the difference between the signal of the magnetic field strength sensor (8) and the desired voltage is calculated with the aid of an analog computer (15).

5. The scanner as claimed in claim 2, wherein the permanent magnet (7) is fastened in a rotationally fixed fashion on the rotor (2) and has a south pole and north pole situated diametrically opposite one another.

6. The scanner as claimed in claim 1, wherein it has means (9) for magnetic shielding.

7. The scanner as claimed in claim 2, wherein one or more magnetic field strength sensors (8) are provided.

8. The scanner as claimed in claim 7, wherein two magnetic field strength sensors (8) are arranged diametrically opposite with reference to a permanent magnet (7).
